(19) United States
(12) Patent Application Publication
(10) Pub. No.: US 2022/0416818 A1
(43) Pub. Date: Dec. 29, 2022

(54) PATTERNED DIELECTRIC FILLINGS IN A METAL CHASSIS

(71) Applicant: Microsoft Technology Licensing, LLC, Redmond, WA (US)

(72) Inventors: Marc HARPER, Snohomish, WA (US); Sakshi SRIVASTAVA, Champaign, IL (US)

(21) Appl. No.: 17/702,080

(22) Filed: Mar. 23, 2022

Related U.S. Application Data
(60) Provisional application No. 63/215,139, filed on Jun. 25, 2021.

(51) Int. Cl. H04B 1/00; H01Q 9/04

(52) U.S. Cl. CPC H04B 1/0064; H01Q 9/0485

(57) ABSTRACT

A communication device includes an antenna positioned within the communication device and configured to radiate a radiofrequency communication signal with a first frequency band and a conductive chassis containing the antenna within the communication device. A conductive wall portion of the conductive chassis forms a conductive exterior surface of the communication device. The antenna is positioned in proximity to the conductive wall portion to radiate the radiofrequency communication signal through the conductive wall portion. The conductive wall portion includes a pattern of apertures. At least one dimension of each aperture is less than or equal to a wavelength of a center frequency of the first frequency band.

### CROSS-REFERENCE TO RELATED APPLICATIONS

This application claims benefit of priority to U.S. Provisional Patent Application No. 63/215,139, entitled “Patterned Dielectric Filings in a Metal Chassis” and filed on Jun. 25, 2021, which is specifically incorporated by reference for all that it discloses and teaches.

### BACKGROUND

Communication devices often include one or more antennas for wireless communications. For example, newer communication devices may support millimeter-wave (mmWave) communications, such as the 5G and 6G technologies.

### SUMMARY

The described technology provides a communication device including an antenna positioned within the communication device and configured to radiate a radiofrequency communication signal with a first frequency band and a conductive chassis containing the antenna within the communication device. A conductive wall portion of the conductive chassis forms a conductive exterior surface of the communication device. The antenna is positioned in proximity to the conductive wall portion to radiate the radiofrequency communication signal through the conductive wall portion. The conductive wall portion includes a pattern of apertures. At least one dimension of each aperture is less than or equal to a wavelength of a center frequency of the first frequency band. A method of building such a communication device is also provided.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example communication device.

FIG. 2 illustrates an internal view of an example antenna array positioned behind a conductive wall that includes patterned dielectric fillings.

FIG. 3 illustrates an exterior view of an example antenna array positioned behind a conductive wall that includes patterned dielectric fillings.

FIG. 4 illustrates realized gain for an example antenna array positioned behind a conductive wall that includes patterned dielectric fillings.

FIG. 5 illustrates electric field distributions through a metal wall with and without patterned dielectric fillings.

FIG. 6 illustrates example operations for building an example antenna array positioned behind a conductive wall that includes patterned dielectric fillings.

FIG. 7 illustrates exampled hardware and software that can be useful in implementing the described technology.

### DETAILED DESCRIPTIONS

Modern wireless communication technologies and industrial design considerations present challenges in antenna design. Communication technology evolutions, such as 5G and 6G, tend to rely on more complex antenna designs and higher frequency bands than previously implemented technologies. Industrial designs push for smaller bezels, external metal chassis, and less exterior plastic on communication devices.

A communication device can be assembled with an antenna positioned inside the communication device behind a metal wall of a conductive device chassis (e.g., a metal casing). The conductive wall includes a pattern of apertures filled with a dielectric material to pass an electric field of a communication signal from the internal antenna to the exterior of the communication device. Accordingly, various implementations of the described technology allow a communication device to benefit from the strength and aesthetic appeal of an external metal chassis while maintaining acceptable electric field distribution from an internal antenna through a conductive wall to the exterior of the communication device.

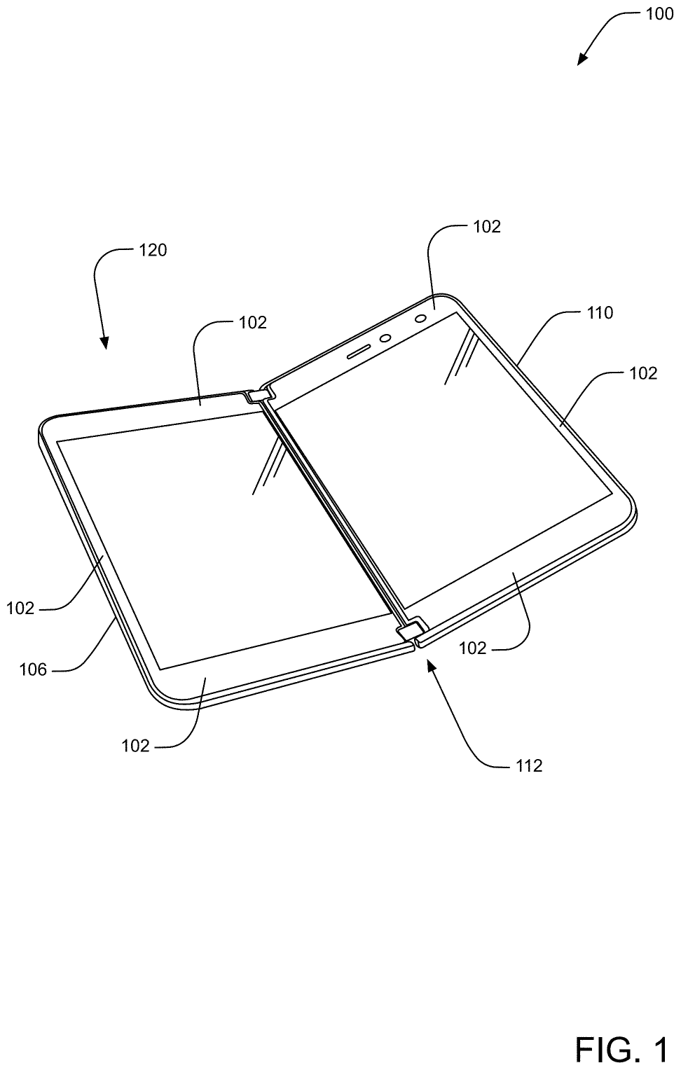

FIG. 1 illustrates an example communication device 100. The communication device 100 is contained within a conductive device chassis (e.g., an exterior metal case), such that a substantial area of at least the thin edges of the device portions is conductive/metal. The communication device 100 is shown as unfolded almost into a flat tablet mode. The bezels 102 are shown at varying widths. The device portion 106 and the device portion 110 are movably attached by a hinge 112. An antenna (not shown) is positioned along an edge of the example communication device 100, such as at the top edge 120, although other edges may be employed for antenna placement.

In various implementations, the conductive device chassis encompasses multiple components of the communications device 100, including without limitation one or more of a display, memory, one or more hardware processors, antennas, communication components, and a power supply (e.g., a battery or power port). For example, in the illustrated implementation, a 5G antenna array is positioned within the conductive device chassis that forms most of the edge boundary of the communication device 100. The 5G antenna array is positioned near the top edge 120, behind a conductive wall (e.g., a metal wall). In some implementations, the conductive wall having patterned dielectric fillings is a portion of the conductive device chassis, although other conductive barriers may be employed.

The patterned dielectric fillings correspond to patterned apertures in the conductive wall of the conductive device chassis. One or more dimensions of the patterned apertures are less than or equal to the operating wavelength of the antenna. In some implementations, such dimensions may be zero to ten times smaller than the operating wavelength. Placement of the antenna (e.g., a 5G antenna array) near the portion of the conductive wall that includes the patterned apertures and dielectric fillings provides an electric field permeable barrier between the antenna and the exterior of the communications device 100. The conductive wall (such as a metal wall) provides improved strength and rigidity to the communication device 100 (e.g., over alternatives using plastic walls or large plastic windows) and presents an attractive industrial design, while the patterned dielectric fillings provide improved radiofrequency transparency over a fully metal wall.

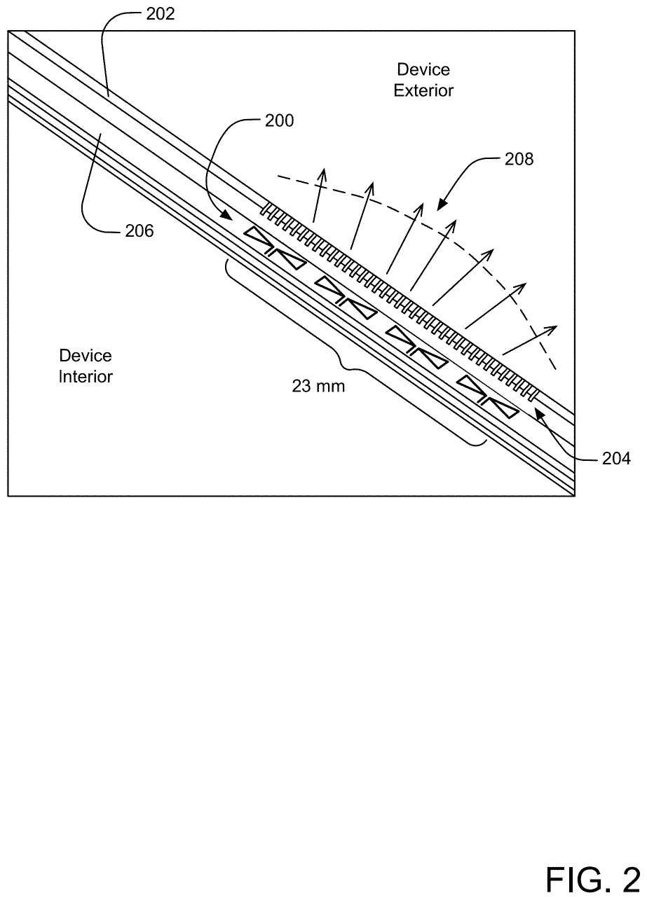

FIG. 2 illustrates an internal view of an example antenna array 200 positioned behind a conductive wall 202 that includes patterned dielectric fillings 204. In an implementation, the conductive wall 202 includes dielectric fillings on the top edge and the bottom edge of the conductive wall 202, although the fillings on the bottom edge of the conductive wall 202 are obscured by a portion of the conductive device chassis 206 in FIG. 2. The antenna array 200 is positioned on the conductive device chassis 206, at the interior of the conductive wall 202 and in the proximity of the patterned dielectric fillings 204. The antenna array 200 radiates a radio frequency communication signal 208 through the conductive wall 202 with the patterned dielectric fillings 204.

The patterned dielectric fillings 204 are illustrated as filling apertures that cut through the entire thickness of the conductive wall 202. The patterned dielectric fillings 204 are affixed to the interior of the apertures an injection molding process, although other methods of filling the apertures with dielectric material may be employed, including without limitation Nano Molding Technology (NMT). One or more of the aperture dimensions are less than or equal to the wavelength of the operating center frequency of the antenna. For example, 5G signals have a wavelength of 1-10 mm, so the one or more of the width, height, thickness, and/or separation of the apertures is less than or equal to 1 mm for a 5G antenna array. In the implementation shown in FIG. 2, the width of the antenna array 200 is approximately 23 mm, and the width of the aperture pattern (e.g., the dielectric filling pattern) along the conductive wall equals or exceeds 23 mm. This relationship provides a benefit of providing electric field permeability along the entire length of the antenna array 200.

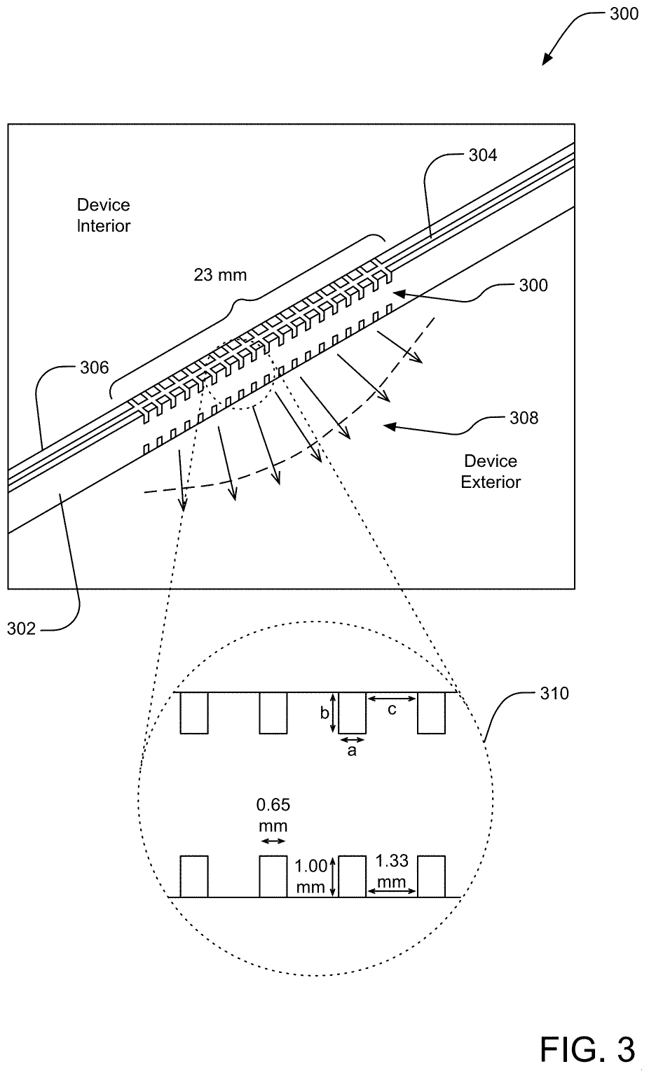

FIG. 3 illustrates an exterior view of an example antenna array (not shown) positioned behind a conductive wall 302 that includes patterned dielectric fillings 300. The conductive wall 302 is also referred to as a “frame.” The conductive wall 302 is part of a conductive device chassis of a communication device. In FIG. 3, the upper and lower ranks of patterned dielectric fillings 300 are apparent, although other implementations may have more ranks or fewer ranks of patterned dielectric fillings 300. In addition, in alternative implementations, the patterned dielectric fillings 300 may be distributed along the conductive wall 302 with a random distribution (e.g., between the upper and lower edges of the conductive wall 302).

The antenna array radiates a radio frequency communication signal 308 through the conductive wall 302 with the patterned dielectric fillings 300. The apertures in the pattern of apertures radiate within a frequency band that is outside the frequency band of the communication signal radiated by the antenna array while excited by the radiofrequency communication signal radiated by the antenna array.

The conductive wall 302 in FIG. 3 includes apertures going through the conductive wall and filled with a dielectric material 304. The dielectric material 304 is also shown as providing electrical insulation between an interior edge 306 of the conductive wall 302 and the exterior of the communication device. Accordingly, the apertures in the pattern of apertures are filled with a dielectric material that also insulates the conductive wall portion from the antenna array.

One or more of the dimensions of the apertures is less than or equal to the wavelength of the operating center frequency of the antenna. In a magnified view 310 of the implementation shown in FIG. 3, the antenna array operates at a wavelength of approximately 10 mm, the dielectric constant εᵣ is 10, the width of each aperture is approximately 0.65 mm, the height of each aperture is approximately 1.00 mm, the thickness of each aperture (and therefore the thickness of the conductive wall 302) is approximately 1.00 mm, and the separation between apertures is approximately 1.30 mm. It should be understood, however, that these dimensions may vary depending on the operating wavelength, the dielectric constant, and potentially other parameters. Furthermore, the width of the antenna array is approximately 23 mm, and the width of the aperture pattern (e.g., the dielectric filling pattern) along the conductive wall 302 equals or exceeds 23 mm.

Performance characteristics can vary with changes in the physical characteristics of the apertures. At least four physical parameters may be modified to adjust the performance of the antenna array: (1) aperture width, designated by “a”; (2) aperture length, designated by “b”; (3) aperture separation, designated by “c”; and the dielectric constant of the conductive wall 302 or frame (including the fillings). Other physical parameters may also have an impact on performance.

The aperture width (a) can be adjusted as a trade-off between gain and impedance bandwidth. If there is a fixed periodicity of the apertures in the frame, the narrower the aperture width is, the wider the overall strip would be. Therefore, the gain is higher at lower frequencies. The impedance bandwidth is, however, narrower when the width of the apertures is reduced.

The aperture length (b) has a strong influence on the gain of the antenna array and the reflection coefficient of the antenna array. Increasing the length of the apertures reduces the frame blockage of the electric field and, therefore, allows the electric field to propagate through the conductive wall 302, thereby increasing the gain.

The aperture periodicity, corresponding to aperture separation (c), is another parameter that affects the performance of the antenna array. If the aperture separation is increased, the gain also increases but the impedance bandwidth narrows. Generally, the periodicity is smaller than λ/2.

The dielectric constant of the frame is another physical parameter that influences performance. The gain increases as the permittivity of the frame increases. That is, the gain increase occurs when the frame is constructed of a conductive wall with dielectric fillings. In another implementation, in which a dielectric material is placed in front of the array in the absence of a conductive wall, an increase in the substrate permittivity does not necessarily transform into an increase of gain, but a shift of the frequency towards lower frequencies is exhibited.

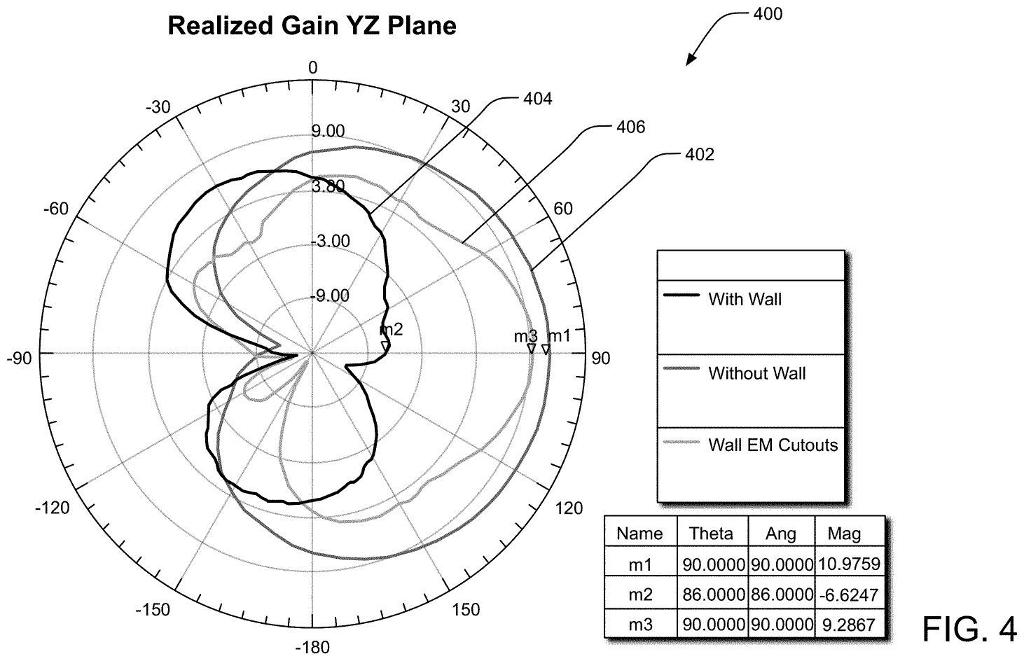

FIG. 4 illustrates realized gain for an example antenna array positioned behind a conductive wall that includes patterned dielectric fillings. A Smith chart 400 shows a realized gain in the YZ plane of three different scenarios:
The curve 402 shows an ideal realized gain without a conductive wall between the antenna and the exterior of the communication device.
The curve 404 shows a realized gain with a conductive wall (and no apertures) between the antenna and the exterior of the communication device.
The curve 406 shows a realized gain with a conductive wall (and no apertures) between the antenna and the exterior of the communication device.

The m1, m2, and m3 indicate three points on the Smith chart. Theta and Ang indicate angles represented in the Smith chart at these points, and Mag indicates the magnitude of the realized gain at these points.

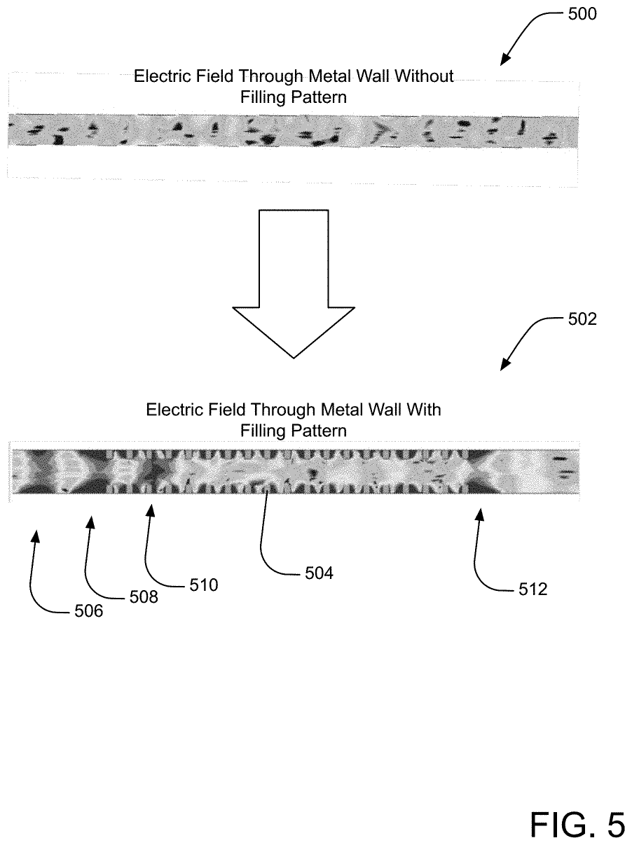

FIG. 5 illustrates electric field distributions 500 and 502 through a metal wall with and without patterned dielectric fillings. (The darker colors indicate a higher electric field, and the darkest colors in the electric field distribution 502 are darker than the darkest colors in the electric field distribution 500.) The electrical field is significantly attenuated in the electric field distribution 500, whereas the electric field distribution 502 (with the patterned dielectric fillings) shows many regions of high electric field passing through the conductive wall. The electric field distribution 502 illustrates a decrease in attenuation (i.e., a strong electric field) around the apertures/dielectric fillings (see filling location 504) as compared to the electric field distribution 500. In addition, the electric field distribution 502 larger regions 506, 508, 510, and 512 of high electric field in other areas of the conductive wall. Accordingly, the electric field distribution 502 shows a higher magnitude of electric field than the electric field distribution 500 and a larger area of the metal wall exhibiting a higher magnitude of electric field.

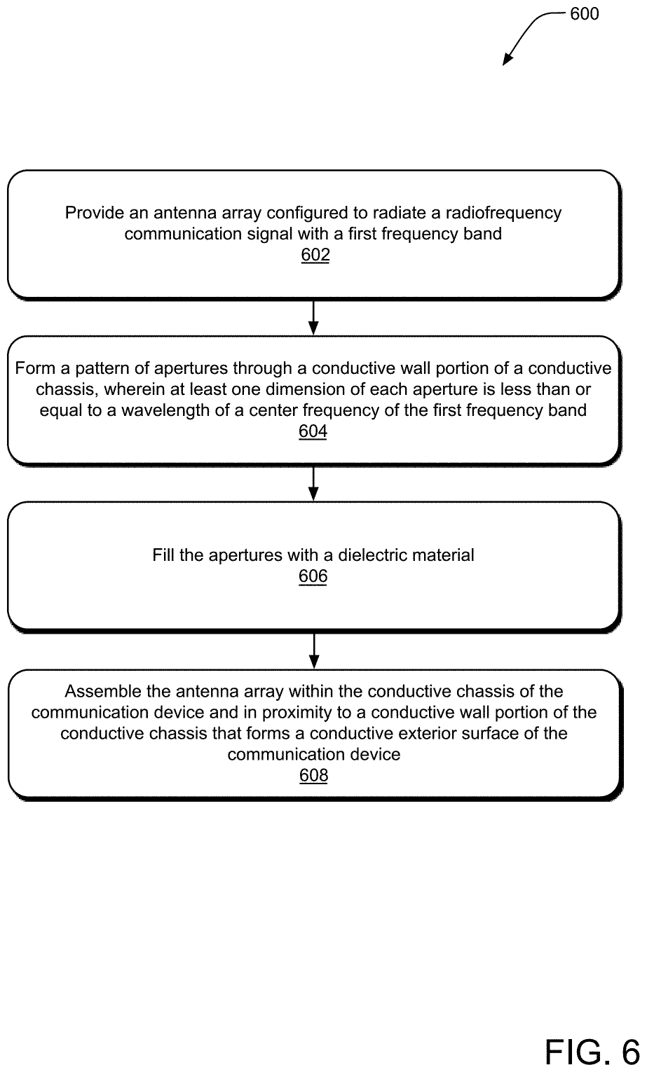

FIG. 6 illustrates example operations 600 for building an example antenna array positioned behind a conductive wall that includes patterned dielectric fillings. A provisioning operation 602 provides an antenna array configured to radiate a radiofrequency communication signal with a first frequency band. The provisioning operation 602 may be performed by a system that cuts slot antennas of the array into the conductive device chassis and connects high-speed transceivers to the slot antennas. Alternative implementations may employ antennas etched or deposited into the conductive device chassis. The antennas may be electrically, capacitively, or inductively driven. A patterning operation 604 forms a pattern of apertures through a conductive wall portion of a conductive chassis, wherein at least one dimension of each aperture is less than or equal to a wavelength of a center frequency of the first frequency band. The patterning operation 604 may be performed by a metal cutting device, an etching system, a laser cutter, a waterjet cutter, and other systems.

A filling operation 606 fills the apertures with a dielectric material. An assembly operation 608 assembles the antenna array within the conductive chassis of the communication device and in proximity to a conductive wall portion of the conductive chassis that forms a conductive exterior surface of the communication device. The antenna array is positioned to radiate the radiofrequency communication signal through the conductive wall portion. In various implementations, the filling operation 606 may be performed by a curing system that flows liquid or power dielectric material into the apertures and solidifies the material within the apertures (e.g., by heating) and other dielectric application systems.

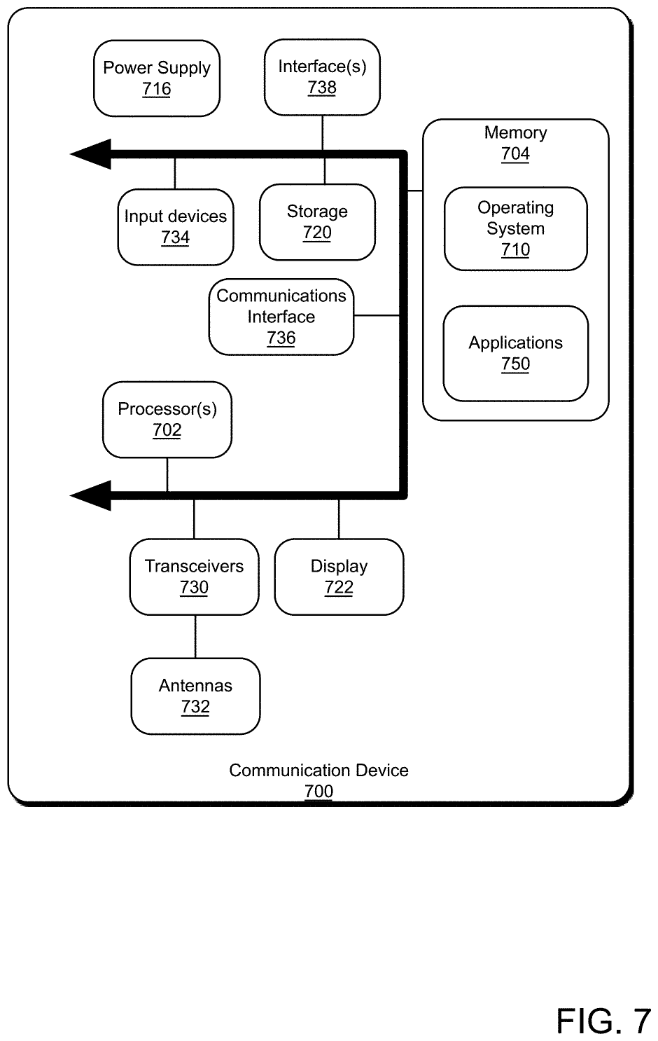

FIG. 7 illustrates an example communication device 700 for implementing the features and operations of the described technology. The communication device 700 may embody a remote control device or a physical controlled device and is an example network-connected and/or network-capable device and may be a client device, such as a laptop, mobile device, desktop, tablet; a server/cloud device; an internet-of-things device; an electronic accessory; or another electronic device. The communication device 700 includes one or more processor(s) 702 and a memory 704. The memory 704 generally includes both volatile memory (e.g., RAM) and nonvolatile memory (e.g., flash memory). An operating system 710 resides in the memory 704 and is executed by the processor(s) 702.

In an example communication device 700, as shown in FIG. 7, one or more modules or segments, such as applications 750, a communication application, and other services, workloads, and software/firmware modules, are loaded into the operating system 710 on the memory 704 and/or storage 720 and executed by processor(s) 702. The storage 720 may include one or more tangible storage media devices and may store physical configurations, communication parameters, corresponding tuning parameters, and other data and be local to the communication device 700 or may be remote and communicatively connected to the communication device 700.

The communication device 700 includes a power supply 716, which is powered by one or more batteries or other power sources and which provides power to other components of the communication device 700. The power supply 716 may also be connected to an external power source that overrides or recharges the built-in batteries or other power sources.

The communication device 700 may include one or more communication transceivers 730, which may be connected to one or more antenna(s) 732 to provide network connectivity (e.g., mobile phone network, Wi-Fi®, Bluetooth®) to one or more other servers and/or client devices (e.g., mobile devices, desktop computers, or laptop computers). The communication device 700 may further include a network adapter 736, which is a type of computing device. The communication device 700 may use the adapter and any other types of computing devices for establishing connections over a wide-area network (WAN) or local-area network (LAN). It should be appreciated that the network connections shown are exemplary and that other computing devices and means for establishing a communications link between the communication device 700 and other devices may be used.

The communication device 700 may include one or more input devices 734 such that a user may enter commands and information (e.g., a keyboard or mouse). These and other input devices may be coupled to the server by one or more interfaces 738, such as a serial port interface, parallel port, or universal serial bus (USB). The communication device 700 may further include a display 722, such as a touch screen display.

The communication device 700 may include a variety of tangible processor-readable storage media and intangible processor-readable communication signals. Tangible processor-readable storage can be embodied by any available media that can be accessed by the communication device 700 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the communication device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

An example communication device includes an antenna positioned within the communication device and configured to radiate a radiofrequency communication signal with a first frequency band and a conductive chassis containing the antenna within the communication device. A conductive wall portion of the conductive chassis forms a conductive exterior surface of the communication device, wherein the antenna is positioned in proximity to the conductive wall portion to radiate the radiofrequency communication signal through the conductive wall portion. The conductive wall portion includes a pattern of apertures, wherein at least one dimension of each aperture is less than or equal to a wavelength of a center frequency of the first frequency band. One or more benefits of this described technology include effective transmission of RF signals through a conductive wall (e.g., a metal wall) of a device chassis.

Another example communication device of any preceding device is provided, wherein the radiofrequency communication signal is a millimeter-wave (mmWave) signal. One or more benefits of this described technology include effective transmission of RF signals through a conductive wall (e.g., a metal wall) of a device chassis in the mmWave spectrum.

Another example communication device of any preceding device is provided, wherein the conductive wall portion is formed from a conductive material, and each aperture in the pattern of apertures is configured to pass an electric field of the radiofrequency communication signal better than the conductive material. One or more benefits of this described technology include effective transmission of RF signals through a conductive wall (e.g., a metal wall) of a device chassis, as provided by the apertures.

Another example communication device of any preceding device is provided, wherein each aperture in the pattern of apertures has a height that is less than or equal to the wavelength of the center frequency of the first frequency band. One or more benefits of this described technology include configuring the apertures to pass RF signals of a first frequency band based on an aperture dimension.

Another example communication device of any preceding device is provided, wherein each aperture in the pattern of apertures has a width that is less than or equal to the wavelength of the center frequency of the first frequency band. One or more benefits of this described technology include configuring the apertures to pass RF signals of a first frequency band based on an aperture dimension.

Another example communication device of any preceding device is provided, wherein each aperture in the pattern of apertures has a width and a height that are less than or equal to the wavelength of the center frequency of the first frequency band. One or more benefits of this described technology include configuring the apertures to pass RF signals of a first frequency band based on two aperture dimensions.

Another example communication device of any preceding device is provided, wherein the antenna has a width dimension, and the apertures in the pattern of apertures are spaced uniformly across the width of the antenna. One or more benefits of this described technology include configuring the apertures to pass RF signals in a somewhat uniform manner across the width of the antenna.

Another example communication device of any preceding device is provided, wherein the apertures in the pattern of apertures are spaced apart by a dimension that is less than or equal to the wavelength of the center frequency of the first frequency band. One or more benefits of this described technology include configuring the apertures to pass RF signals of a first frequency band based on aperture spacings.

Another example communication device of any preceding device is provided, wherein the apertures in the pattern of apertures radiate within a second frequency band that is outside the first frequency band while excited by the radiofrequency communication signal radiated by the antenna. One or more benefits of this described technology include radiating a second RF signal in a second frequency band from the apertures, providing dual-band performance.

Another example communication device of any preceding device is provided, wherein the pattern of apertures is filled with a dielectric material. One or more benefits of this described technology include a smooth surface on the conductive wall.

An example method of building a communication device includes providing an antenna configured to radiate a radiofrequency communication signal with a first frequency band, forming a pattern of apertures through a conductive wall portion of a conductive chassis, wherein at least one dimension of each aperture is less than or equal to a wavelength of a center frequency of the first frequency band. The example method also includes assembling the antenna within the conductive chassis of the communication device and in proximity to the conductive wall portion of the conductive chassis that forms a conductive exterior surface of the communication device, wherein the antenna is positioned to radiate the radiofrequency communication signal through the conductive wall portion.

Another example method of any preceding method is provided, wherein the radiofrequency communication signal is a millimeter-wave (mmWave) signal.

Another example method of any preceding method is provided, wherein the conductive wall portion is formed from a conductive material, and each aperture in the pattern of apertures is configured to pass an electric field of the radiofrequency communication signal better than the conductive material.

Another example method of any preceding method is provided, wherein each aperture in the pattern of apertures has a height that is less than or equal to the wavelength of the center frequency of the first frequency band.

Another example method of any preceding method is provided, wherein each aperture in the pattern of apertures has a width that is less than or equal to the wavelength of the center frequency of the first frequency band.

Another example method of any preceding method is provided, wherein each aperture in the pattern of apertures has a width and a height that are less than or equal to the wavelength of the center frequency of the first frequency band.

Another example method of any preceding method is provided, wherein the antenna has a width dimension, and the apertures in the pattern of apertures are spaced uniformly across the width of the antenna.

Another example method of any preceding method is provided, wherein the apertures in the pattern of apertures are spaced apart by a dimension that is less than or equal to the wavelength of the center frequency of the first frequency band.

Another example method of any preceding method is provided, wherein the apertures in the pattern of apertures radiate within a second frequency band that is outside the first frequency band while excited by the radiofrequency communication signal radiated by the antenna.

Another example method of any preceding method is provided, further including filling the apertures with a dielectric material.

An example system for building a communication device includes means for providing an antenna configured to radiate a radiofrequency communication signal with a first frequency band and means for forming a pattern of apertures through a conductive wall portion of a conductive chassis, wherein at least one dimension of each aperture is less than or equal to a wavelength of a center frequency of the first frequency band. The example method also includes means for assembling the antenna within the conductive chassis of the communication device and in proximity to the conductive wall portion of the conductive chassis that forms a conductive exterior surface of the communication device, wherein the antenna is positioned to radiate the radiofrequency communication signal through the conductive wall portion.

Another example system of any preceding system is provided, wherein the radiofrequency communication signal is a millimeter-wave (mmWave) signal.

Another example system of any preceding system is provided, wherein the conductive wall portion is formed from a conductive material, and each aperture in the pattern of apertures is configured to pass an electric field of the radiofrequency communication signal better than the conductive material.

Another example system of any preceding system is provided, wherein each aperture in the pattern of apertures has a height that is less than or equal to the wavelength of the center frequency of the first frequency band.

Another example system of any preceding system is provided, wherein each aperture in the pattern of apertures has a width that is less than or equal to the wavelength of the center frequency of the first frequency band.

Another example system of any preceding system is provided, wherein each aperture in the pattern of apertures has a width and a height that are less than or equal to the wavelength of the center frequency of the first frequency band.

Another example system of any preceding system is provided, wherein the antenna has a width dimension, and the apertures in the pattern of apertures are spaced uniformly across the width of the antenna.

Another example system of any preceding system is provided, wherein the apertures in the pattern of apertures are spaced apart by a dimension that is less than or equal to the wavelength of the center frequency of the first frequency band.

Another example system of any preceding system is provided, wherein the apertures in the pattern of apertures radiate within a second frequency band that is outside the first frequency band while excited by the radiofrequency communication signal radiated by the antenna.

Another example system of any preceding system is provided, further including filling the apertures with a dielectric material.

While this specification contains many specific implementation details, these should not be construed as limitations on the scope of any inventions or of what may be claimed, but rather as descriptions of features specific to particular embodiments of a particular described technology. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A communication device comprising:
an antenna positioned within the communication device and configured to radiate a radiofrequency communication signal with a first frequency band; and
a conductive chassis containing the antenna within the communication device, a conductive wall portion of the conductive chassis forming a conductive exterior surface of the communication device, wherein the antenna is positioned in proximity to the conductive wall portion to radiate the radiofrequency communication signal through the conductive wall portion, the conductive wall portion including a pattern of apertures, wherein at least one dimension of each aperture is less than or equal to a wavelength of a center frequency of the first frequency band.

2. The communication device of claim 1, wherein the radiofrequency communication signal is a millimeter-wave (mmWave) signal.

3. The communication device of claim 1, wherein the conductive wall portion is formed from a conductive material, and each aperture in the pattern of apertures is configured to pass an electric field of the radiofrequency communication signal better than the conductive material.

4. The communication device of claim 1, wherein each aperture in the pattern of apertures has a height that is less than or equal to the wavelength of the center frequency of the first frequency band.

5. The communication device of claim 1, wherein each aperture in the pattern of apertures has a width that is less than or equal to the wavelength of the center frequency of the first frequency band.

6. The communication device of claim 1, wherein each aperture in the pattern of apertures has a width and a height that are less than or equal to the wavelength of the center frequency of the first frequency band.

7. The communication device of claim 1, wherein the antenna has a width dimension, and the apertures in the pattern of apertures are spaced uniformly across the width dimension of the antenna.

8. The communication device of claim 1, wherein the apertures in the pattern of apertures are spaced apart by a dimension that is less than or equal to the wavelength of the center frequency of the first frequency band.

9. The communication device of claim 1, wherein the apertures in the pattern of apertures radiate within a second frequency band that is outside the first frequency band while excited by the radiofrequency communication signal radiated by the antenna.

10. The communication device of claim 1, wherein the pattern of apertures is filled with a dielectric material.

11. A method of building a communication device, the method comprising:
providing an antenna configured to radiate a radiofrequency communication signal with a first frequency band;
forming a pattern of apertures through a conductive wall portion of a conductive chassis, wherein at least one dimension of each aperture is less than or equal to a wavelength of a center frequency of the first frequency band; and
assembling the antenna within the conductive chassis of the communication device and in proximity to the conductive wall portion of the conductive chassis that forms a conductive exterior surface of the communication device, wherein the antenna is positioned to radiate the radiofrequency communication signal through the conductive wall portion.

12. The method of claim 11, wherein the radiofrequency communication signal is a millimeter-wave (mmWave) signal.

13. The method of claim 11, wherein the conductive wall portion is formed from a conductive material, and each aperture in the pattern of apertures is configured to pass an electric field of the radiofrequency communication signal better than the conductive material.

14. The method of claim 11, wherein each aperture in the pattern of apertures has a height that is less than or equal to the wavelength of the center frequency of the first frequency band.

15. The method of claim 11, wherein each aperture in the pattern of apertures has a width that is less than or equal to the wavelength of the center frequency of the first frequency band.

16. The method of claim 11, wherein each aperture in the pattern of apertures has a width and a height that are less than or equal to the wavelength of the center frequency of the first frequency band.

17. The method of claim 11, wherein the antenna has a width dimension, and the apertures in the pattern of apertures are spaced uniformly across the width dimension of the antenna.

18. The method of claim 11, wherein the apertures in the pattern of apertures are spaced apart by a dimension that is less than or equal to the wavelength of the center frequency of the first frequency band.

19. The method of claim 11, wherein the apertures in the pattern of apertures radiate within a second frequency band that is outside the first frequency band while excited by the radiofrequency communication signal radiated by the antenna.

20. The method of claim 11, further comprising:
filling the apertures with a dielectric material.
